(19) United States
(12) Patent Application Publication
(10) Pub. No.: US 2014/0032469 A1
(43) Pub. Date: Jan. 30, 2014

(54) ESTIMATING POTENTIAL MESSAGE VIEWING RATES OF TWEETS

(71) Applicants: Miki Enoki, Kanagawa-ken (JP); Akiko Suzuki, Tokyo-to (JP); Michiaki Tatsubori, Kanagawa (JP)

(72) Inventors: Miki Enoki, Kanagawa-ken (JP); Akiko Suzuki, Tokyo-to (JP); Michiaki Tatsubori, Kanagawa (JP)

(73) Assignee: INTERNATIONAL BUSINESS MACHINES CORPORATION, Armonk, NY (US)

(21) Appl. No.: 13/568,841

(22) Filed: Aug. 7, 2012

Related U.S. Application Data
(63) Continuation of application No. 13/556,825, filed on Jul. 24, 2012.

(51) Int. Cl. G06N 5/02

(52) U.S. Cl. 706/46

(57) ABSTRACT

A method of estimating a viewing rate of a targeted message in a multicast messaging system is disclosed. A processor may be used to determine a first probability that at least one follower selects a received multicast message that accesses the targeted message using a processor. A second probability is calculated for the probability that the at least one follower accesses the targeted message from the selected multicast message. A third probability that the at least one follower views the targeted message is determined from the first probability and the second probability to determine the viewing rate of the targeted message. A message may be targeted for sending over the multicast messaging system at a time selected based on the determined third probability.

### CROSS-REFERENCE TO RELATED APPLICATIONS

This application is a Continuation of U.S. Non-Provisional application Ser. No. 13/556,825, entitled “ESTIMATING POTENTIAL MESSAGE VIEWING RATES OF TWEETS”, filed on Jul. 24, 2012, which is incorporated herein by reference in its entirety.

### BACKGROUND

The present invention relates to multicast messaging, and more specifically, to determining a viewing rate of a message sent over a multicast messaging system.

Multicasting messaging is becoming a common method of communication via social networking systems. Multicast messaging systems provide a message distribution network that sends messages from one user known as an issuer to one or more users who subscribe to or “follow” the issuer in order to receive messages from the issuer. An example of such a multicasting messaging system is Twitter. The user may receive the multicast messages via a device that may be connectable to the network, such as a computer or a portable device, such as a laptop, phone, smartphone, iPad, etc. For various reasons, the follower may not read all of the messages he/she receives. For instance, the follower may receive a large quantity of messages beyond the follower's capacity or interest to read. Also, the follower may read only when the follower logs on to his or her device, and thus tends to read only those messages that have been received at a time close to the time at which the user has logged on. Knowing whether a follower reads a content of the issued messages is of interest to businesses and marketers.

### SUMMARY

According to one embodiment, a method of estimating a viewing rate of a targeted message in a multicast messaging system, includes: determining a first probability that at least one follower selects a received multicast message that accesses the targeted message using a processor; calculating a second probability that the at least one follower accesses the targeted message from the selected multicast message; and determining a third probability that the at least one follower views the targeted message from the first probability and the second probability to determine the viewing rate of the targeted message.

According to another embodiment, a method of targeting a message to a plurality of followers over a multicast messaging system, includes: determining a message viewing rate for the plurality of followers during the selected sampling time interval using a processor by determining for each of the plurality of followers: a first probability that a follower selects a received multicast message that accesses the targeted message, a second probability that the follower accesses the targeted message from the selected multicast message, and a third probability that the follower views the targeted message from the first probability and the second probability; and targeting the message for sending over the multicast messaging system at a time selected based on the determined third probability for the plurality of followers.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 illustrates a network of users in communication with each other via participation in an exemplary multicasting messaging system;

FIG. 2 show an exemplary timeline that includes messages received by a follower over the exemplary network of FIG. 1;

FIG. 3 shows an exemplary histogram plotting a follower's target message viewing frequency with respect to a timeline distance with which the follower looks back to read the message;

FIG. 4 shows an exemplary table of message information that may be compiled using publicly available information;

FIG. 5 shows an exemplary follower table that provides a link between an original message and a related response message;

FIG. 6 shows an exemplary message response table that includes message information for a follower;

FIG. 7 shows a detailed view of the diagram of FIG. 6 illustrating a probability of looking back in a timeline;

FIG. 8 shows a detailed view of the diagram of FIG. 6 illustrating a probability of touching a timeline;

FIG. 9 shows an exemplary flowchart illustrating a method for determining a viewing rate of a message;

FIG. 10 shows an exemplary histogram of reading density for various delay times between receiving a message and responding to the message with a mention; and

FIG. 11 shows an exemplary system for determining the viewing rate of a multi-cast message.

### DETAILED DESCRIPTION

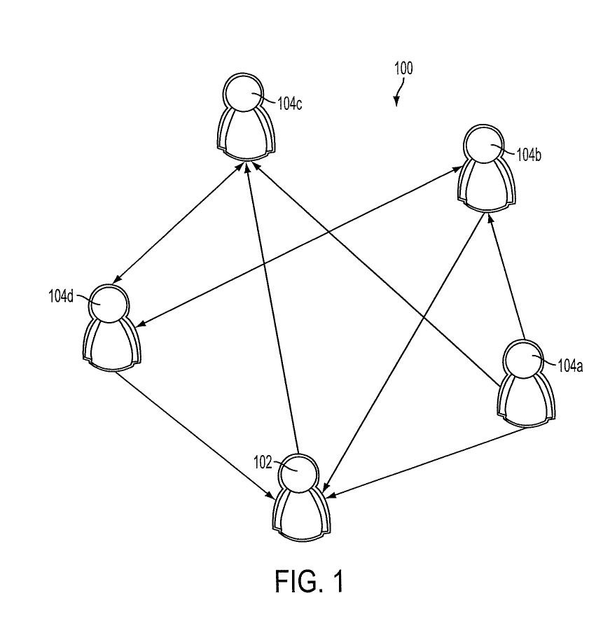

FIG. 1 illustrates a network 100 of users in communication with each other via participation in an exemplary multicasting messaging system. The multicasting messaging system includes at least one issuer 102 and one or more followers 104a-d. The issuer 102 generally sends out messages over the multicasting messaging system and these messages are received by the followers 104a-104d. In an exemplary embodiment, such multicasting messages are sent over the Internet to various Internet-connectable devices, such as computer, laptops, smartphones, iPads, etc. An example of a multicasting messaging system is Twitter, which allows an issuer to send messages of a limited size to followers. The messages themselves are known as tweets. Tweets may have hyperlinks that a follower may select in order to access a website or other site that may provide a targeted message such as an advertisement or an announcement. While messages are generally referred to herein as tweets, this is not meant as a limitation of the disclosure and other multicast messaging systems are considered suitable for analysis using the methods disclosed herein. The follower is directed to and “reads” the targeted message when he “touches” the tweet, i.e., selects the hyperlink. In addition to subscribing to an issuer 102, a follower 104a-104d can send his or her own messages. The follower may send a message or response to the issuer in response to having read a message from the issuer 102. The follower may also provide a mention of the original tweet within the text of a response message, in which case the response becomes a “retweet” that in turn is viewable by other followers of the follower. A mention includes a name of the sender (the issuer) of the original message and a hyperlink to the original sender.

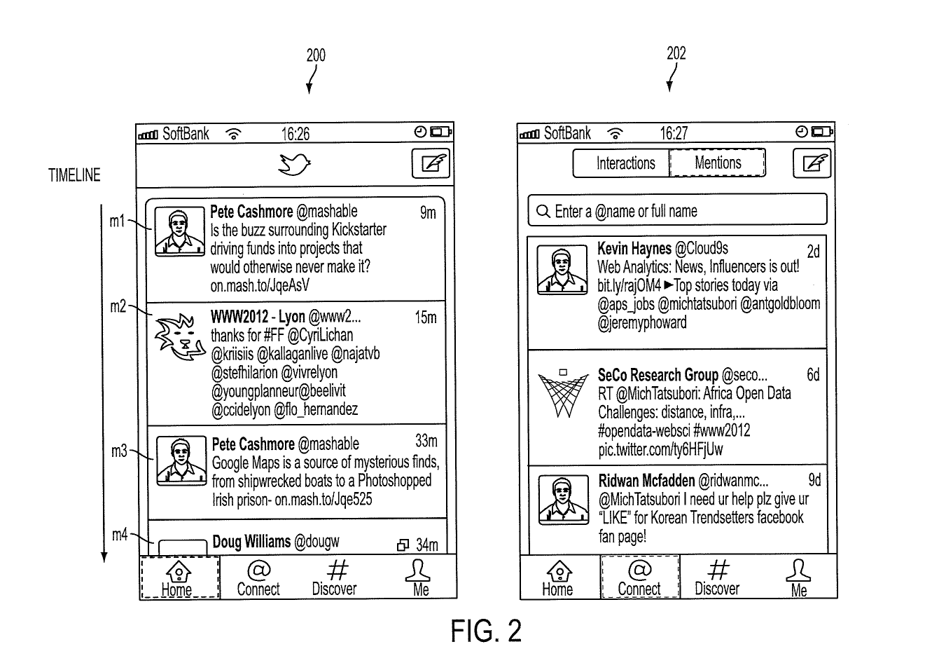

FIG. 2 shows an exemplary main timeline 200 that includes messages received by a follower over the exemplary network 100 of the multicasting messaging system. A main timeline 200 is a listing of incoming messages in the order in which they are received. The main timeline 200 generally includes all received tweets and is non-exclusive. The timeline may be viewed on any of the network-connectable devices disclosed herein. The messages are ordered along a timeline (TL) starting with the most recent message m₁ at one end and proceeding to older messages m₂, m₃, m₄, etc. as one moves along the timeline toward the other end. An age of a message may be indicated by a timestamp on the message. Alternately, the age of the message may be indicated by its position on the timeline, i.e., the number of messages between the particular message and the most recent message (front end of the timeline), otherwise known as the message's “distance.” The exemplary main timeline 200 is displayed for illustrative purposes on a smart phone interface which allows the user to move through the timeline using various scrolling methods. With such interfaces, the follower generally logs on to the system at various times of the day and reads the messages in the main timeline 200 upon logging on to the device. In general, the follower tends to read the most recent messages that are near a front of the main timeline 200 and works backwards in time. A follower's log-on time is generally unrelated to message arrival times. Thus, a message may be near a front of a timeline or may be several messages back in the timeline when the user logs on. FIG. 2 also shows a special timeline 202 for selected messages that include a mention of another user in the message. Special timelines may be set up around various viewing parameters. For illustrative purposes, the exemplary special timeline 202 includes messages that include a mention of the issuer “@michtatsubori” The inclusion of a mention of the original tweet (or the issuer of the original tweet) in a response to an original message, particularly for older messages, generally indicates that the follower has read the original message from the special timeline 202 rather than from the main timeline 200.

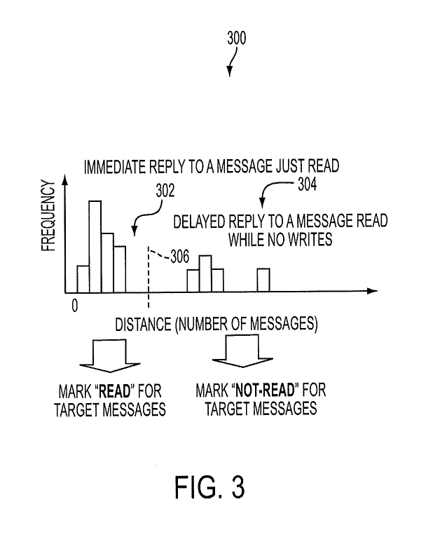

The follower tends to read most recently posted messages first. The follower also has the ability to skip backwards through the main timeline 200 to read messages which have been received a long time prior to the follower logging on. A ‘long’ time may be 15 minutes, a couple of hours or a few days, depending on the follower's message viewing habits. In general, any particular follower's timeline reading habit may be characterized by a first group of messages that are read immediately and a group of messages that are read because the follower found them in the special timeline 202 to read it. A threshold ‘read’ time separates the timeline messages into these two groups of messages, as shown in FIG. 3.

FIG. 3 shows an exemplary histogram 300 plotting a follower's target message viewing frequency with respect to a timeline distance with which the follower looks back to read the message. The time when a target message might be read is determined as substantially the time when the follower issues a response message to the target message. A read threshold 306 separates viewed targeted messages into recent messages 302 and old messages 304. In general, recent messages 302 (short distance) may be more likely to have their target messages read by the follower looking in the main timeline 200. Older messages 304 (long distance) are generally less likely to have their target messages read due to finding the message in the main timeline 200, but rather the older target messages may read by the follower finding he message in the special timeline 202. The methods disclosed herein may be used to determine a viewing rate of a message linking to a targeted message based on the different viewing habits for a follower with respect to recent messages 302 and older messages 304.

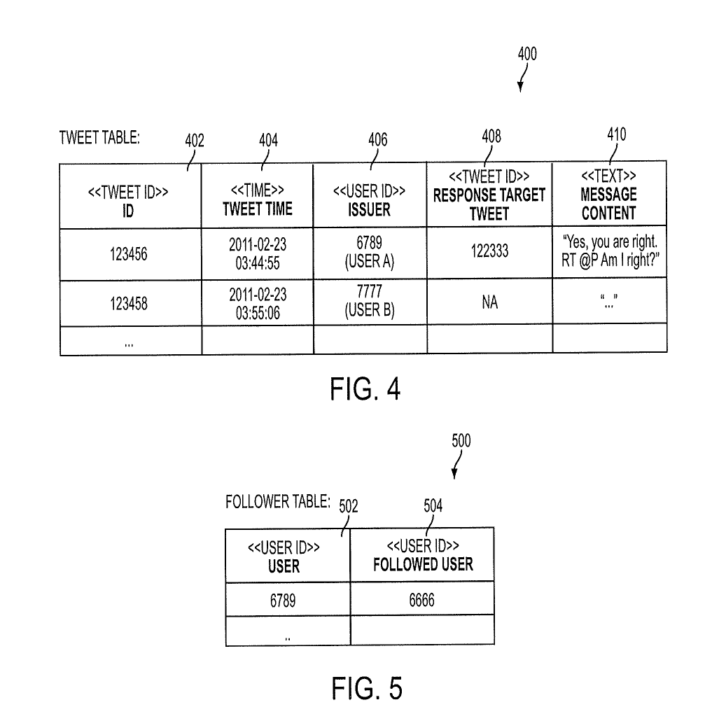

FIG. 4 shows an exemplary message table (tweet table) 400 that may be compiled using publicly available information. The exemplary message table 400 includes columns for various field entries. Exemplary columns include message ID 402, a time stamp (Tweet Time) 404 indicating the time at which the message or tweet is sent, an issuer ID (Issuer) 406 of the entity issuing the message, a response target message ID (Response Target Tweet) 408 that records the tweet ID of a related retweet, and the message content 410 of the tweet.

FIG. 5 shows an exemplary follower table 500 that provides columns for field entries for issuer ID 502 and a follower ID 504. The entries in the exemplary follower's table provide a link between original message and related messages that are sent after reading the original message.

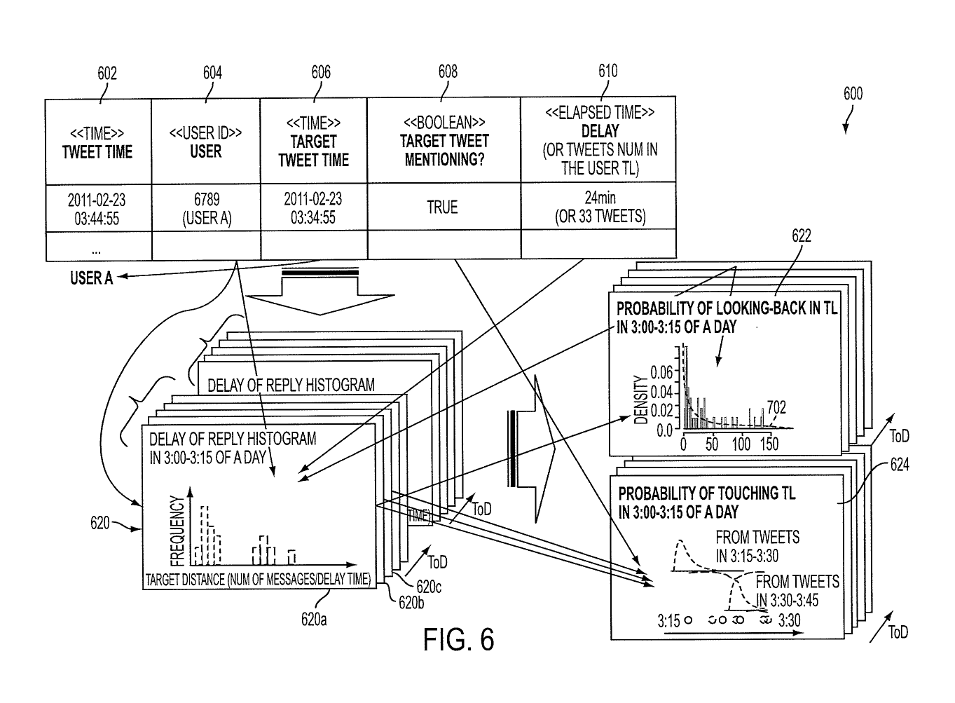

FIG. 6 shows an exemplary Message Response Table 600 that includes message information for a particular follower, referred to herein as Follower A. The message response table 600 includes a tweet time 602 that stores the time at which a tweet is sent, an issuer ID 604, and a target tweet time 606 which is a time of an original tweet that the current tweet (listed in column 602) is responding to. The table 600 further includes a column 608 indicating whether or not the tweet includes a mention of the original tweet in its message. When a follower sends a response to a recent tweet, there is no need to provide a mention of the follower in the original tweet responded to by the follower. However, a short time delay between a tweet and a corresponding response is sufficient to indicate that the follower has read a targeted message. However, when responding to an older message, it is generally because the follower found the original message in the special timeline 202 but not via the main timeline 200. In such cases, the follower tends to be mentioned in the original tweet responded to by the follower. Therefore for older messages, tracking whether the original tweet mentions the follower allows one to determine whether the follower found the original tweet in the special timeline 202 or in the main timeline 200. The table also includes a column 610 indicating the delay between the issued tweet and the response tweet. The data stored in the response tweet table may be used to create a plurality of histograms such as histograms 620 indicating a delay of response to a tweet. Sampling intervals are generally every 15 minutes, meaning that the followers viewing habits are observed over 15 minute intervals. It is to be noted, however that any suitable sampling interval may be used. Histogram 620a shows a histogram of Follower A's reading behavior from 3:00 p.m. to 3:15 p.m. Histograms for sampling times 3:15 p.m. to 3:30 p.m. (histogram 620b), 3:30 p.m. to 3:45 p.m. (histogram 620c), and so forth may be also computed. As shown, during exemplary time interval 3:00 p.m. to 3:15 p.m., the Follower A reads a number of very recent messages, a smaller number of messages at an intermediate distance in the timeline, and an even smaller number of messages at a long distance in the timeline. The histograms 620 may be used to determine a probability curve of looking back in the timeline for the respective sampling intervals, such as is shown in diagram 622.

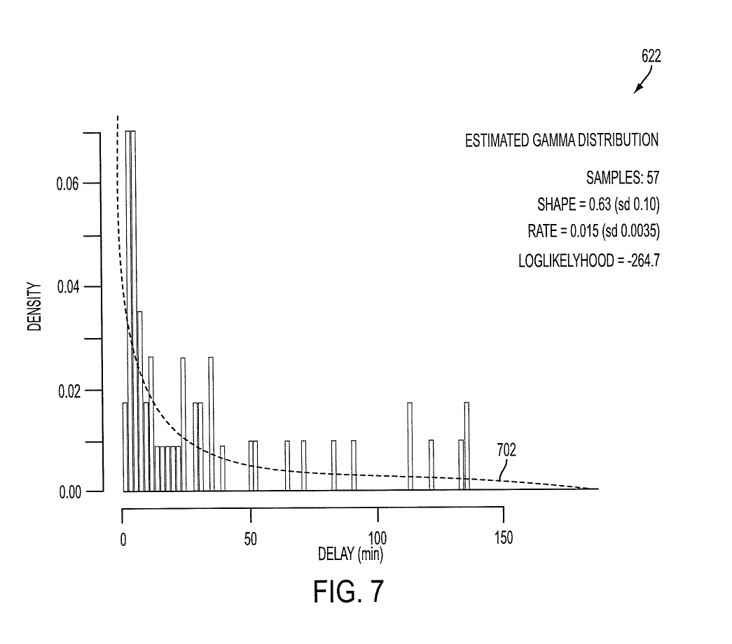

FIG. 7 shows a detailed view of the diagram 622 for a probability of looking back in a timeline. Density, or reading frequency is plotted along the y-axis and time delay between receiving a tweet and sending a message in response to the received tweet is plotted along the x-axis. The delay time may be found in column 610 of the composed response tweet table 600, for instance. In the exemplary diagram of FIG. 7, the reading frequency is fitted to a gamma distribution 702. Various statistical parameters of the fitted gamma distribution are shown. The gamma distribution and its statistical parameters may be used for later determining a probability of looking back a given timeline distance for the follower and is referred to as Pₜ^{(A)} (TL is looked back for δₜ^{(A)}(τ) or more).

Returning to FIG. 6, the histograms 620 and/or the composed response tweet table 600 may be used to determine a probability that Follower A touches the timeline during the sampling interval or, in other words, selects a link to access the targeted message, as shown in diagram 624. Pₜ^{(A)}(TL is touched) refers to a probability that User A selects a targeted messages for reading.

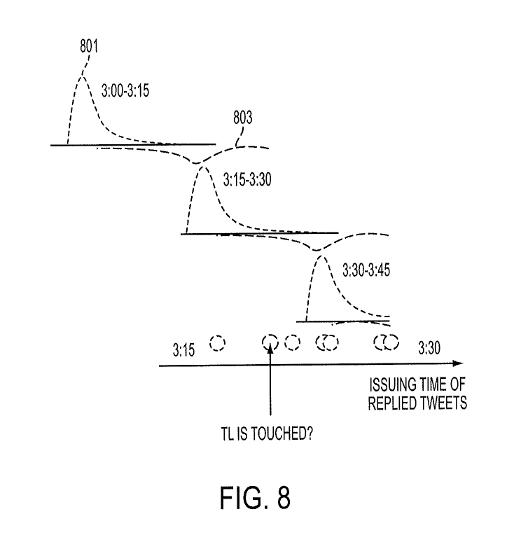

FIG. 8 shows a detailed view of the diagram 624 for a probability of touching a timeline. The probability distributions are shown in a sequence over consecutive sampling periods. The probability of User A reading a targeted message at a given time of day (ToD), such as during exemplary sampling interval 3:00 p.m.-3:15 p.m. is given by Eq. (1):

$${P}^{( A in ToD )} ( touching TL ) = \frac{{F}^{( A in ToD )} ( touching TL )}{\begin{matrix}{F}^{( A in ToD )} ( touching TL ) + \\ {F}^{( A in ToD )} ( not touching TL )\end{matrix}} \qquad Eq . ( 1 )$$

In Eq. (1), the term

F^{(A in ToD)}(touching TL)=Σ_{∀m;t}_{_{ToD}}_{(m)=T}_{_{ToD}}P^{(A in ToD)}(tweets replied with t_{delay}(m) are read in TL) Eq. (2)

is a function determined by a summation of probabilities related to responses sent after a delay that is less than a selected reading threshold of the follower, as indicated by 306 in FIG. 3. The term of Eq. (2) is shown as curve 801 in FIG. 8. The term:

F^{(A in ToD)}(not touching TL)=Σ_{∀m;t}_{_{ToD}}_{(m)=T}_{_{ToD}}(P^{(A in ToD)}(tweets replied with t_{delay}(m) are read in TL)) Eq. (3)

is a function determined by a summation of probabilities related to responses sent after a delay that is greater than a selected reading threshold of the follower, as indicated by 306 in FIG. 3. The term of Eq. (3) is shown as curve 803 in FIG. 8.

From these probabilities related to diagram 622 and diagram 624 a message viewing behavior of User A may be determined. The probability of User A reading a message m after a delay (τ) may be determined using Eq. (4) below:

P^{(A)}(m_{τ})=1−Π_{t>τ}{1−Pₜ^{(A)}(TL is looked back for δ_{τ}^{(A)}(τ) or more)·Pₜ^{(A)}(TL is touched)} Eq. (4)

where τ is a time at which a follower receives a message, t is a current time and δₜ^{(A)}(τ) is a number of messages between the message m_{τ} and the front of the timeline, or in other words, a delay time between timeslot t and message time τ. A summation of viewing probabilities for all of the followers under consideration may then be used to determine a viewing rate or a predicted viewing rate of a targeted message.

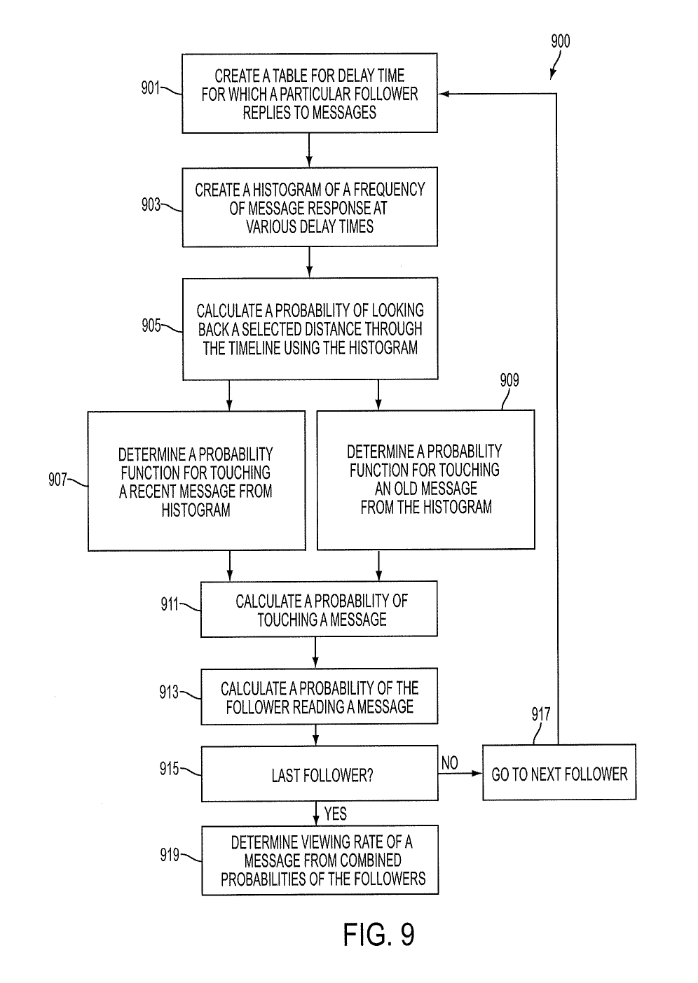

FIG. 9 shows an exemplary flowchart 900 for determining a viewing rate of a message. At box 901, a table such as table 600 in FIG. 6 is compiled of response delay times for a particular follower of a message issuer. In box 903, a “delay of response” histogram such as histograms 620 is created from the table compiled in box 901. In box 905, a probability of looking back in a timeline is determined by fitting a probability function such as a gamma distribution to the histogram. In box 907, a probability function for touching a recent message is determined. In an exemplary embodiment, this probability function may be determined from Eq. (2). Similarly, in box 909 a probability function for touching an old message is determined. In an exemplary embodiment, this probability function may be determined from Eq. (3). The probability functions of box 907 and 909 may be determined using the histograms of box 903, for example, wherein a message is recent or old as determined by a message viewing threshold. In box 911, a probability of touching a message is determined from the probability functions determined in boxes 907 and 909, as shown in Eq. (1). In box 913, a probability is calculated for whether a follower reads a targeted message using the results of box 911 and box 905. In box 915, the flowchart loops back to box 901 if there are other followers (box 917). Otherwise, when the probability calculations have been performed for a last user, box 919 determines a viewing rate of a message from combined probabilities of the followers.

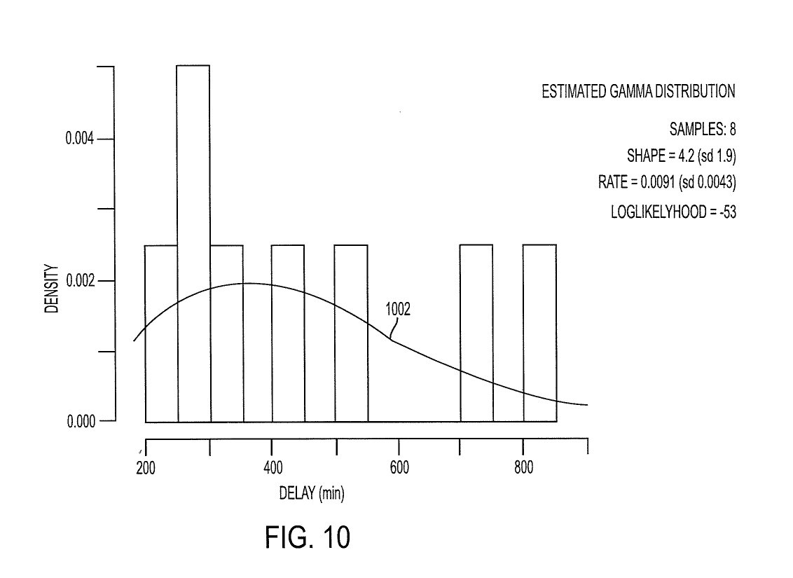

The methods described herein may also be used to determine a viewing rate of a targeted message based on mentions. As discussed above, a mentioning tweet is a tweet that includes mention of another user of the messaging system. FIG. 10 shows an exemplary histogram of reading density for various delay times between receiving a message and responding to the message with a mention. A fitting function 1002 is fit to the histogram to determine a probability of responding to an original message with a mention of the original message in the responding message, given a delay time between the original message and its corresponding responding message.

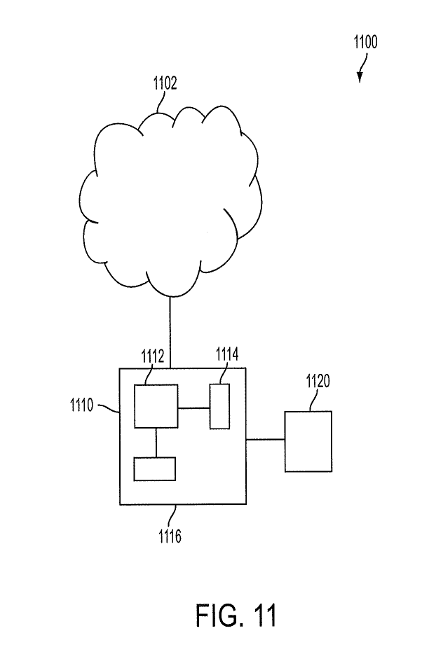

FIG. 11 shows an exemplary system 1100 for determining the viewing rate of the message. In various embodiments, the exemplary system includes network 1102 that may include the Internet, for example, and a control unit 1110 configured to perform the various methods disclosed herein. The control unit 1110 is coupled to the network 1102 and is able to access various information disclosed herein about the messages sent over the network 1102. In one aspect, the control unit 1110 may be a computer-based system that includes one or more processors (such as microprocessors) 1112, one or more data storage devices (such as solid state-memory, hard drives, tape drives, etc.) 1114 for storing programs or models and data, and computer programs and models 1116 for use by the processor 1112. In one aspect, the control unit 1110 may provide output data to a display 1120 that may be used by an operator.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. An apparatus for estimating a viewing rate of a targeted message in a multicast messaging system, comprising:
a processor configured to:
determine a first probability that at least one follower selects a received multicast message that accesses the targeted message using a processor;
calculate a second probability that the at least one follower accesses the targeted message from the selected multicast message; and
determine a third probability that the at least one follower views the targeted message from the first probability and the second probability to determine the viewing rate of the targeted message.

2. The apparatus of claim 1, wherein the at least one follower includes a plurality of followers, the processor being further configured to determine the third probability for the plurality of followers and sum the third probabilities for the plurality of followers to estimate the viewing rate of the targeted message.

3. The apparatus of claim 1, wherein the received multicast message is presented to the at least one follower on a timeline that includes one or more multicast messages, and wherein the first probability is related to a timeline distance.

4. The apparatus of claim 1, wherein the processor is further configured to create a histogram that relates a frequency with which the follower sends a response message in response to the received message against a delay time between the received message and the response message.

5. The apparatus of claim 4, wherein the processor is configured to determine the first probability by fitting a probability distribution function to the created histogram.

6. The apparatus of claim 5, wherein the fitted probability distribution function is a gamma distribution function.

7. The apparatus of claim 1, wherein the processor is further configured to calculate the second probability by:
selecting a message viewing threshold in the histogram;
calculating a first fitting function for messages that are responded to within a time that is less than the message viewing threshold;
determining a second fitting function for messages that are responded to in a time that is greater than the message viewing threshold; and
determining the second probability from the first fitting function and the second fitting function.

8. The apparatus of claim 4, wherein the processor is further configured to create the histogram based on message responses that provide a mention of the received multicast message in the response.

9. The apparatus of claim 1, wherein the processor is further configured to determine the viewing rate of the targeted message over a sampling interval.

10. The apparatus of claim 9, wherein the sampling interval is one of a plurality of sampling intervals, the processor being further configured to determine the viewing rate of the targeted message over the plurality of sampling intervals and select a sampling interval to sending the targeted message.

11. The apparatus of claim 9, further comprises a display device coupled to the processor configured to display output from the processor.

12. An apparatus for targeting a message to a plurality of followers over a multicast messaging system, comprising:
a processor configured to determining a message viewing rate for the plurality of followers during the selected sampling time interval by determining for each of the plurality of followers:
a first probability that a follower selects a received multicast message that accesses the targeted message,
a second probability that the follower accesses the targeted message from the selected multicast message, and
a third probability that the follower views the targeted message from the first probability and the second probability; and
target the message for sending over the multicast messaging system at a time selected based on the determined third probability for the plurality of followers.

13. The apparatus of claim 12, wherein the received multicast message is presented to the follower on a timeline that includes one or more multicast messages, and wherein the processor is configured to determine the first probability with respect to a timeline distance.

14. The apparatus of claim 12, wherein the processor is further configured to create a histogram that relates a frequency with which the follower sends a response message in response to the received message against a delay time between the received message and the response message.

15. The apparatus of claim 14, wherein the processor is further configured to determine the first probability by fitting a probability distribution function to the created histogram.

16. The apparatus of claim 14, wherein the fitted probability distribution function is a gamma distribution function.

17. The apparatus of claim 12, wherein the processor is further configured to determine the second probability by:
selecting a message viewing threshold in the histogram;
calculating a first fitting function for messages that are responded to within a time that is less than the message viewing threshold;
determining a second fitting function for messages that are responded to in a time that is greater than the message viewing threshold; and
determining the second probability from the first fitting function and the second fitting function.

18. The apparatus of claim 14, wherein the processor is further configured to create the histogram based on message responses that provide a mention of the original message in the response.

19. The apparatus of claim 12, further comprising a display device coupled to the processor configured to display output from the processor.
